(19) United States
(12) Patent Application Publication
(10) Pub. No.: US 2024/0214142 A1
(43) Pub. Date: Jun. 27, 2024

(54) BEAM FAILURE DETECTION FOR SINGLE-DCI BASED MULTI-TRP SCHEMES

(71) Applicant: Telefonaktiebolaget LM Ericsson (publ), Stockholm (SE)

(72) Inventors: Siva MURUGANATHAN, Stittsville (CA); Shiwei GAO, Nepean (CA)

(21) Appl. No.: 18/261,161

(22) PCT Filed: Jan. 14, 2022
(86) PCT No.: PCT/IB2022/050314

§ 371 Date: Jul. 12, 2023

Related U.S. Application Data
(60) Provisional application No. 63/138,733, filed on Jan. 18, 2021.

(51) Int. Cl. H04L 5/00; H04W 24/08

(52) U.S. Cl. CPC H04L 5/0048; H04L 5/0053; H04L 5/0094; H04W 24/08

(57) ABSTRACT

A method, network node and wireless device (WD) for beam failure detection for single downlink control information (DCI) based multi-transmission reception point (TRP) schemes. In one embodiment, a network node is configured to configure the WD with at least one control resource set (CORESET). The network node is also configured to activate at least two transmission configuration indicator (TCI) states. Further, the network node is configured to determine at least one beam failure resource set, each beam failure resource set including a beam failure detection reference signal (BFD-RS), where a BFD-RS is a quasi-colocation (QCL) Type D source in at least one of the at least two activated TCI states for at least one CORESET

### FIELD

The present disclosure relates to wireless communications, and in particular, to beam failure detection for single-downlink control information (DCI) based multi-transmission reception point (TRP) schemes.

### BACKGROUND

3^{rd} Generation Partnership Project (3GPP) New Radio (NR, also called 5^{th} Generation or 5G) uses CP-OFDM (Cyclic Prefix Orthogonal Frequency Division Multiplexing) in both downlink (DL) (i.e., from a network node, gNB, or base station, to a wireless device (WD), also called user equipment or UE) and uplink (UL) (i.e., from WD to gNB). Discrete Fourier Transform (DFT) spread OFDM is also supported in the uplink. In the time domain, NR downlink and uplink transmissions are organized into equally sized subframes of 1 millisecond (ms) each. A subframe is further divided into multiple slots of equal duration. The slot length depends on subcarrier spacing. For subcarrier spacing of Δf=15 kHz, there is only one slot per subframe, and each slot consists of 14 OFDM symbols.

Data scheduling in NR is typically at the slot level. An example is shown in FIG. 1 with a 14-symbol slot, where the first two symbols contain physical downlink control channel (PDCCH) and the rest contains physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×2^{μ}) kHz where μ∈{0,1,2,3,4}. Δf=15 kHz is the basic subcarrier spacing. The slot durations at different subcarrier spacings are given by 1/2^{μ} ms.

In the frequency domain, a system bandwidth is divided into resource blocks (RBs), each RB corresponding to 12 contiguous subcarriers. The RBs are numbered starting with 0 from one end of the system bandwidth. The basic NR physical time-frequency resource grid is illustrated in FIG. 2, where only one resource block (RB) within a 14-symbol slot is shown. One OFDM subcarrier during one OFDM symbol interval forms one resource element (RE).

### QCL and TCI States

Several signals can be transmitted from different antenna ports of a same base station. These signals can have the same large-scale properties such as Doppler shift/spread, average delay spread, or average delay. These antenna ports are then said to be quasi co-located (QCL).

If the WD knows that two antenna ports are QCL with respect to a certain parameter (e.g., Doppler spread), the WD can estimate that parameter based on a signal at one of the antenna ports and apply that estimate for receiving a signal on the other antenna port. Typically, the first antenna port is represented by a measurement reference signal such as Channel State Information Reference Signal (CSI-RS) or Synchronization Signal Block (SSB), known as source reference signal (RS), and the second antenna port is a demodulation reference signal (DMRS), known as a target RS.

For instance, if antenna ports A and B are QCL with respect to average delay, the WD can estimate the average delay from the signal received from antenna port A and assume that the signal received from antenna port B has the same average delay. This is useful for demodulation since the WD can know beforehand the properties of the channel, which for instance helps the WD in selecting an appropriate channel estimation filter.

Information about what assumptions can be made regarding QCL is signaled to the WD from the network. In NR, four types of QCL relations between a transmitted source RS and transmitted target RS were defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced to facilitate beam management with analog beamforming and is known as spatial QCL. There is currently no strict definition of spatial QCL, but the understanding is that if two transmitted antenna ports are spatially QCL, the WD can use the same Rx beam to receive signals associated the two antenna ports.

A WD can be configured through radio resource control (RRC) signaling with up to 128 Transmit Configuration Indicator (TCI) states for PDSCH in frequency range 2 (FR2) and up to 8 in FR1, depending on WD capability.

Each TCI state contains QCL information, i.e., one or two source DL RSs, each source RS associated with a QCL type. For example, a TCI state contains a pair of reference signals, each associated with a QCL type. For example, two different CSI-RSs {CSI-RS1, CSI-RS2} are configured in the TCI state as {qcl-Type1,qcl-Type2}={Type A, Type D}. This means that the WD can derive Doppler shift, Doppler spread, average delay, delay spread from CSI-RS1 and Spatial Rx parameter (i.e., the RX beam to use) from CSI-RS2.

The list of TCI states can be interpreted as a list of possible beams transmitted from the network or a list of possible TRPs used by the network to communicate with the WD.

### Beam Failure Detection (BFD) in NR

BFD and Beam Failure Recovery (BFR) are features introduced in NR since 3GPP Release 15 (3GPP Rel-15). For the purpose of BFD, the network configures the WD with BFD reference signals (synchronization signal block (SSB), channel state information reference signal (CSI-RS) or both SSB/CSI-RS resources), and the WD declares beam failure when the number of beam failure instance indications from the physical layer reaches a configured threshold before a configured timer expires. SSB-based BFD is based on the SSB associated to the initial DL bandwidth part (BWP) and can only be configured for the initial DL BWPs and for DL BWPs containing the SSB associated to the initial DL BWP. For other DL BWPs, Beam Failure Detection can only be performed based on CSI-RS.

Resources for BFD can be configured via radio resource control (RRC) (as part of the SpCellConfig, within each dedicated BWP configuration—BWP-DownlinkDedicated, in an RRCReconfiguration or RRCResume message) within the RadioLinkMonitoringConfig Information Element (IE), as follows:

| | |
|---|---|
| RadioLinkMonitoringConfig ::= | SEQUENCE { |
| failureDetectionResourcesToAddModList | SEQUENCE |

(SIZE(1..maxNrofFailureDetectionResources)) OF RadioLinkMonitoringRS
OPTIONAL, -- Need N

| | |
|---|---|
| failureDetectionResourcesToReleaseList | SEQUENCE |

(SIZE(1..maxNrofFailureDetectionResources)) OF RadioLinkMonitoringRS-
Id OPTIONAL, -- Need N

| | |
|---|---|
| beamFailureInstanceMaxCount | ENUMERATED {n1, n2, n3, n4, |

n5, n6, n8, n10} OPTIONAL, -- Need R

| | |
|---|---|
| beamFailureDetectionTimer | ENUMERATED {pbfd1, pbfd2, |
| pbfd3, pbfd4, pbfd5, pbfd6, pbfd8, pbfd10} | OPTIONAL, -- Need R |

...
}

| | |
|---|---|
| RadioLinkMonitoringRS ::= | SEQUENCE { |
| radioLinkMonitoringRS-Id | RadioLinkMonitoringRS-Id, |
| purpose | ENUMERATED { beamFailure, rlf, both}, |
| detectionResource | CHOICE { |
| ssb-Index | SSB-Index, |
| csi-RS-Index | NZP-CSI-RS-ResourceId |

```
  },
  ...
}
```

The configured thresholds for BFD are Q_{out,LR} and Q_{in,LR}. which may correspond to the default value of rlmInSyncOutOfSyncThreshold, as described in 3GPP Technical Specification (TS) 38.133, for Qₒᵤₜ, and to the value provided by rsrp-ThresholdSSB or rsrp-ThresholdBFR-r16, respectively.

-- Serving cell specific MAC and PHY parameters for a SpCell:

| | |
|---|---|
| SpCellConfig ::= | SEQUENCE { |
| servCellIndex | ServCellIndex |

OPTIONAL, -- Cond SCG

| | |
|---|---|
| reconfigurationWithSync | ReconfigurationWithSync |

OPTIONAL, -- Cond ReconfWithSync

| | |
|---|---|
| rlf-TimersAndConstants | SetupRelease { RLF-TimersAndConstants |
| } | OPTIONAL, -- Need M |
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M
...
}

. . .
rlmInSyncOutOfSyncThreshold
BLER threshold pair index for IS/OOS indication generation,
see TS 38.133, table 8.1.1-1. n1 corresponds to the value 1.
When the field is absent, the WD applies the value 0.
Whenever this is reconfigured, WD resets N310 and N311,
and stops T310, if running. Network does not include this field.

The physical layer in the WD assesses the radio link quality according to the set q̅₀ of resource configurations against the threshold Q_{out,LR}. For the set q̅₀, the WD assesses the radio link quality only according to periodic CSI-RS resource configurations, or SS/PBCH blocks on the primary cell (PCell) or the primary secondary cell (PSCell), that are quasi co-located with the demodulation references signal (DM-RS) of PDCCH receptions monitored by the WD. The WD applies the Q_{in,LR} threshold to the Layer 1 reference signal received power (L1-RSRP) measurement obtained from a SS/PBCH block. The WD applies the Q_{in,LR} threshold to the L1-RSRP measurement obtained for a CSI-RS resource after scaling a respective CSI-RS reception power with a value provided by powerControlOffsetSS.

In non-DRX (non-discontinuous reception) mode operation, the physical layer in the WD provides an indication to higher layers when the radio link quality for all corresponding resource configurations in the set q̅₀ that the WD uses to assess the radio link quality is worse than the threshold Q_{out,LR}. In other words, if at least one resource is above the threshold Q_{out,LR}, the physical layer does not indicate BFD to the higher layers. The physical layer informs the higher layers when the radio link quality is worse than the threshold Q_{out,LR} with a periodicity determined by the maximum between the shortest periodicity among the periodic CSI-RS configurations, and/or SS/PBCH blocks on the PCell or the PSCell, in the set q̅₀ that the WD uses to assess the radio link quality and 2 msec. In DRX mode operation, the physical layer provides an indication to higher layers when the radio link quality is worse than the threshold Q_{out,LR} with a periodicity determined, for example, in 3GPP TS 38.133.

### Beam Failure Detection based on TCI State

According to 3GPP TS 38.213, a WD can be provided, for each bandwidth part (BWP) of a serving cell, a set q̅₀ of periodic CSI-RS resource configuration indices by failureDetectionResources; a set q̅₁ of periodic CSI-RS resource configuration indices; and/or SS/PBCH block indices by candidateBeamRSList; or candidateBeamRSListExt-r16 or candidateBeamRSSCellList-r16 for radio link quality measurements on the BWP of the serving cell.

If the WD is not provided q̅₀ by failureDetectionResources or beamFailureDetectionResourceList for a BWP of the serving cell, the WD determines the set q̅₀ to include periodic CSI-RS resource configuration indices with same values as the RS indices in the RS sets indicated by TCI-State (i.e., the activated TCI state) for respective control resource sets (CORESETs) that the WD uses for monitoring PDCCH. If there are two RS indices in a TCI state, the set q̅₀ includes RS indices with QCL-TypeD configuration for the corresponding TCI states. The WD expects the set go to include up to two RS indices.

This is indicated as part of the TCI state configuration (within the PDSCH configuration, PDSCH-Config, in a DL BWP configuration):

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex OPTIONAL, -- Need R |
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

In current 3GPP specifications, each PDCCH configuration (which is part of a DL BWP configuration, up to 3 per BWP per cell) comprises one or multiple Control Resource Sets (CORESET)s, configured as follows:

| | |
|---|---|
| PDCCH-Config ::= | SEQUENCE { |
| controlResourceSetToAddModList | SEQUENCE(SIZE (1..3)) OF |
| ControlResourceSet | OPTIONAL, -- Need N |

(...)
}

If the WD is configured with multiple CORESETs, the WD monitors multiple CORESET for a given BWP. Each CORESET is configured with a list of TCI states. As one can see below, each CORESET has a list of TCI states configured which is given by the list tci-StatesPDCCH-ToAddList. Among the list of TCI states configured to a CORESET, one of the TCI states will be activated via a medium access control (MAC) control element (CE) command ‘TCI State Indication for WD-specific PDCCH MAC CE’ given in clause 6.1.3.15 of 3GPP TS 38.321. If the activated TCI state for the CORESET contains a source RS index with QCL-TypeD configuration, then the received beam (i.e., spatial Rx filters) for receiving the CORESET is derived from the beam that was used to receive the source RS.

-- ASN1START
-- TAG-CONTROLRESOURCESET-START

| | |
|---|---|
| ControlResourceSet ::= | SEQUENCE { |
| controlResourceSetId | , |

(...)

| | |
|---|---|
| tci-StatesPDCCH-ToAddList | SEQUENCE(SIZE (1..maxNrofTCI- |
| StatesPDCCH)) OF TCI-StateId | OPTIONAL, -- Cond NotSIB1-initialBWP |

(...)
}
-- TAG-CONTROLRESOURCESET-STOP
-- ASN1STOP

The WD actions related to Beam Failure Detection (BFD) are mainly specified in medium access control (MAC) specifications (3GPP TS 38.321). In the case the WD is configured with Multi-Radio Dual Connectivity (MR-DC), the WD is configured with a Secondary Cell Group (SCG).

When the WD is configured with SCG, two MAC entities are configured to the WD: one for the master cell group (MCG) and one for the SCG.

The functions of the different MAC entities in the WD operate independently unless otherwise specified. The timers and parameters used in each MAC entity are configured independently unless otherwise specified. The Serving Cells, cell radio network temporary identifier (C-RNTI), radio bearers, logical channels, upper and lower layer entities, LCGs, and Hybrid Automatic Repeat reQuest (HARQ) entities considered by each MAC entity refer to those mapped to that MAC entity unless otherwise specified.

If the MAC entity is configured with one or more SCells, there are multiple downlink shared channel (DL-SCH) and there may be multiple uplink shared channel (UL-SCH) as well as multiple radio access channel (RACH) per MAC entity; one DL-SCH, one UL-SCH, and one RACH on the SpCell, one DL-SCH, zero or one UL-SCH and zero or one RACH for each SCell.

If the MAC entity is not configured with any SCell, there is one DL-SCH, one UL-SCH, and one RACH per MAC entity.

According to the current MAC specification, BFD procedure is defined per Serving Cell, e.g., special cell (SpCell), or a secondary cell (SCell) in a given cell group (e.g., MCG and/or SCG). BFD is used for indicating to the serving network node (gNB) of a new SSB or CSI-RS when beam failure is detected on the serving SSB(s)/CSI-RS(s).

Beam failure is detected by counting beam failure instance (BFI) indications from the lower layers to the MAC entity. If beamFailureRecoveryConfig is reconfigured by upper layers during an ongoing Random Access (RA) procedure for beam failure recovery for SpCell, the MAC entity stops the ongoing Random Access procedure and initiates a Random Access procedure using the new configuration.

### 3GPP Release 17 (Rel-17) Single Frequency Network (SFN)-based PDCCH Diversity for Single-DCI based Multi-TRP Schemes

In 3GPP NR Rel-17, support for PDCCH diversity for single-DCI based multi-TRP schemes has been considered. One of the schemes that has been considered in 3GPP Rel-17 is support for enhanced single frequency network (SFN) transmission of PDCCH from multiple TRPs. FIG. 3 shows an illustration of an example of a single frequency network (SFN) type transmission of PDCCH. In this scheme, PDCCH DM-RS is associated with two TCI states (each associated to a different TRP). The same PDCCH (i.e., the same DCI) is transmitted over the same control channel resources from both TRPs. As shown in FIG. 3. TRP1 uses TCI state k0 to transmit the PDCCH, and TRP2 uses TCI state k1 to transmit the PDCCH. When a PDCCH demodulation reference signal (DM-RS) is associated with two TCI states, at the receiver, the WD is to determine a way to utilize the two TCI states when performing channel estimation on PDCCH DM-RS.

To enable SFN-based PDCCH transmission over two TRPs, two TCI states need to be activated for a CORESET (i.e., the two TCI states activated are from the list of TCI states configured for the CORESET). When the WD is receiving a PDCCH DM-RS with a CORESET activated with two TCI states, the WD may perform synchronization and estimation of long term channel properties using the DL RS (e.g., TRS) in both TCI states in parallel. For example, it obtains two channel delay spreads. The WD may then combine these measurements to obtain the channel properties of the SFN channel. For example, it can compute as a weighted average of the delay spread. This average is then used as input to the channel estimation algorithm for the PDCCH DM-RS. Note that the PDCCH and PDCCH DM-RS are transmitted as SFN while the TRS are not transmitted as SFN, they are transmitter “per TRP” (see TRS #1 and TRS #2 in FIG. 3). So the measurements on the TRS gives the WD some information on whether one TRP is dominating over the other, e.g., if the WD is close to one of the TRPs or if the channel towards one of the TRPs is blocked. An algorithm in the WD can then decide to only use estimates from one of the TRS (one TCI states) as the SFN transmission is weak (meaning that even if PDCCH is SFN transmitted, one TRP is dominating).

When a WD is configured with a CORESET that has two activated TCI states, the WD needs to be able to receive a PDCCH from two TRPs simultaneously. In FR1, WD antennas are typically omni-directional and thus are able to receive signals from all TRPs simultaneously. In FR2, this typically means that the WD needs to have two receive panels, each receiving from one TRP.

TRS from each TRP can be used by the WD to estimate time, frequency, and other channel properties such as delay spread and/or Doppler spread associated with the TRP, while SSB or CSI-RS can be used by the WD to determine direction information of each TRP and the best receive beam or panel for each TRP.

### Non-SFN based PDCCH Repetition for Single-DCI based Multi-TRP Schemes

In 3GPP NR Rel-17, it has been proposed to enhance PDCCH reliability with multiple TRPs by repeating a PDCCH in non-SFN'ed fashion over different TRPs. An example is shown in FIG. 4, where a PDCCH is repeated over two TRPs at different times, both containing the same DCI.

The PDCCH are repeated in two PDCCH candidates each associated with one of the two TRPs. The two PDCCH candidates are linked, i.e., the location of one PDCCH candidate can be obtained from the other PDCCH candidate. The PDCCH candidates are in different search space sets associated with different CORESETs as demonstrated in FIG. 5.

When performing PDCCH detection, a WD may detect PDCCH individually in each PDCCH candidate or jointly by soft combining of the two linked PDCCH candidates. The linked PDCCH candidates can be in two linked search space sets, each associated with a different CORESET. Each of the two associated CORESETs may be activated with one TCI state associated with the respective TRP.

### 3GPP Rel-17 Agreements on BFD for Multi-TRP

As described above, in 3GPP NR Rel-15/16, a single beam failure detection resource set q̅₀ is supported for each BWP of a serving cell. In 3GPP NR Rel-17, support for beam failure detection resource sets per TRP has been considered. The motivation for this is to detect a beam failure on a per TRP basis (instead of detecting beam failure across all TRPs). To this end, the following consideration has been made:

Consideration:
For M-TRP beam failure detection, support independent BFD-RS configuration per-TRP, where each TRP is associated with a BFD-RS set:
   For further study (FFS): The number of BFD RSs per BFD-RS set, the number of BFD-RS sets, and number of BFD RSs across all BFD-RS sets per DL BWP;
   Support at least one of explicit and implicit BFD-RS configuration:
      With explicit BFD-RS configuration, each BFD-RS set is explicitly configured:
         FFS: Further study QCL relationship between BFD-RS and CORESET;
      FFS: How to determine implicit BFD-RS configuration, if supported;
For M-TRP new beam identification:
   Support independent configuration of new beam identification RS (NBI-RS) set per TRP if NBI-RS set per TRP is configured:
      FFS: detail on association of BFD-RS and NBI-RS; and/or
      Support the same new beam identification and configuration criteria as Rel-16, including L1-RSRP, threshold.

In the above consideration, the beam failure detection resource set is referred to as beam failure detection—reference signal (BFD-RS) set. Note that 3GPP RAN1 has not yet decided whether the per-TRP beam failure detection resource sets should be explicitly configured (i.e., via RRC configuration of failureDetectionResources) or implicitly configured (i.e., when beam failure detection resource sets are determined through activated TCI state of CORESETs).

### SUMMARY

Some embodiments advantageously provide methods, network nodes, and wireless devices for beam failure detection for single-DCI based multi-TRP schemes.

In some embodiments, a network node is configured to configure at least one control resource set (CORESET) and activate at least transmission configuration (TCI) state; determine at least one reference signal (RS) as a quasi-colocation (QCL) type D source reference signal in the at least one TCI state for the at least one CORESET as at least one beam failure detection RS; and include the determined at least one beam failure detection RS in at least one beam failure resource set.

In some embodiments, a wireless device is configured to receive a configuration of at least one control resource set (CORESET) and an activation of at least transmission configuration (TCI) state; and determine at least one beam failure detection reference signal (BFD-RS) in at least one beam failure resource set.

According to one aspect, a network node configured to communicate with a wireless device, WD, includes processing circuitry configured to: configure the WD with at least one control resource set, CORESET; activate a first and a second transmission configuration indicator, TCI, state for one of the at least one CORESET; and determine at least one beam failure detection resource set, each of the at least one beam failure detection resource set including at least one beam failure detection reference signal, BFD-RS, a BFD-RS being a reference signal associated with one of the first and second activated TCI states.

According to this aspect, in some embodiments, the reference signal associated with one of the first and second activated TCI states is a quasi-colocation, QCL, Type D reference signal. In some embodiments, the at least one beam failure detection resource set comprises a single beam failure detection resource set including a first BFD-RS being a reference signal associated with the first activated TCI state and a second BFD-RS being a reference signal associated with the second activated TCI state. In some embodiments, the at least one CORESET comprises a second CORESET activated with a third activated TCI state, and a single beam failure detection resource set includes a third BFD-RS being a reference signal associated with the third activated TCI state. In some embodiments, the at least one CORESET comprises a second CORESET activated with a third activated TCI state and a forth activated TCI state, and a single beam failure detection resource set includes a third BFD-RS being a reference signal associated with the third activated TCI state and a fourth BFD-RS being a reference signal associated with the fourth activated TCI state. In some embodiments, the reference signal associated with one of the third and fourth activated TCI states is a quasi-colocation, QCL, Type D reference signal. In some embodiments, a first beam failure detection resource set comprises a reference signal of QCL Type D associated with the first activated TCI state. In some embodiments, a second beam failure detection resource set comprises a reference signal of QCL type D associated with the second activated TCI state. In some embodiments, configuring at least one CORESET includes configuring two linked CORESETs and activating a TCI state for each of the two linked CORESETS. In some embodiments, determining at least one beam failure detection resource set includes reference signals associated with the activated TCI states for both of the two linked CORESETs.

According to another aspect, a method in a network node configured to communicate with a wireless device, WD, includes: configuring the WD with at least one control resource set, CORESET; activating a first and a second transmission configuration indicator, TCI, state for one of the at least one CORESET; and determining at least one beam failure detection resource set, each of the at least one beam failure detection resource set including at least one beam failure detection reference signal, BFD-RS, a BFD-RS being a reference signal associated with one of the first and second activated TCI states.

According to this aspect, in some embodiments, the reference signal associated with one of the first and second activated TCI states is a quasi-colocation, QCL, Type D reference signal. In some embodiments, the at least one beam failure detection resource set comprises a single beam failure detection resource set including a first BFD-RS being a reference signal associated with the first activated TCI state and a second BFD-RS being a reference signal associated with the second activated TCI state. In some embodiments, the at least one CORESET comprises a second CORESET activated with a third activated TCI state, and a single beam failure detection resource set includes a third BFD-RS being a reference signal associated with the third activated TCI state. In some embodiments, the at least one CORESET comprises a second CORESET activated with a third activated TCI state and a forth activated TCI state, and a single beam failure detection resource set includes a third BFD-RS being a reference signal associated with the third activated TCI state and a fourth BFD-RS being a reference signal associated with the fourth activated TCI state. In some embodiments, the reference signal associated with one of the third and fourth activated TCI states is a quasi-colocation, QCL, Type D reference signal. In some embodiments, a first beam failure detection resource set comprises a reference signal of QCL Type D associated with the first activated TCI state. In some embodiments, a second beam failure detection resource set comprises a reference signal of QCL type D associated with the second activated TCI state. In some embodiments, configuring at least one CORESET includes configuring two linked CORESETs and activating a TCI state for each of the two linked CORESETS. In some embodiments, determining at least one beam failure detection resource set includes reference signals associated with the activated TCI states for both of the two linked CORESETs.

According to another aspect, a wireless device, WD, configured to communicate with a network node, includes a radio interface configured to receive a configuration of at least one control resource set, CORESET, and an indication of activation of a first and a second transmission configuration indicator, TCI, states for one of the at least one CORESET. The WD also includes processing circuitry (84) in communication with the radio interface and configured to determine at least one beam failure detection reference signal, BFD-RS, in at least one beam failure detection resource set, each of the at least one BFD-RS being a quasi-colocation, QCL, Type D reference signal associated with one of the first and second activated TCI states.

According to this aspect, in some embodiments, the reference signal associated with one of the first and second activated TCI states is a quasi-colocation, QCL, Type D reference signal. In some embodiments, the at least one beam failure detection resource set comprise a single beam failure detection resource set including a first BFD-RS being a reference signal associated with the first activated TCI states and a second BFD-RS being a reference signal associated with the second activated TCI state. In some embodiments, the configuration of at least one CORESET includes a configuration of two linked CORESETs and an indication of an activated TCI state for each of the two linked CORESETs.

According to yet another aspect, a method in wireless device configured to communicate with a network node includes: receiving a configuration of at least one control resource set, CORESET, and an indication of activation of a first and a second transmission configuration indicator, TCI, states for one of the at least one CORESET; and determining at least one beam failure detection reference signal, BFD-RS, in at least one beam failure detection resource set, each of the at least one BFD-RS being a quasi-colocation, QCL, Type D reference signal associated with one of the first and second activated TCI states.

According to this aspect, in some embodiments, the reference signal associated with one of the first and second activated TCI states is a quasi-colocation, QCL, Type D reference signal. In some embodiments, the at least one beam failure detection resource set comprise a single beam failure detection resource set including a first BFD-RS being a reference signal associated with the first activated TCI states and a second BFD-RS being a reference signal associated with the second activated TCI state. In some embodiments, the configuration of at least one CORESET includes a configuration of two linked CORESETs and an indication of an activated TCI state for each of the two linked CORESETs.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example NR time-domain structure with 15 kHz subcarrier spacing;

FIG. 2 is an example NR physical resource grid;

FIG. 3 is an example illustration of SFN type transmission of PDCCH over two TRPs;

FIG. 4 is an example of PDCCH repetition from multiple TRPs;

FIG. 5 is an illustration of linked PDCCH candidates in different search space sets in different CORESETs (the linked PDCCH candidates are used to repeat PDCCH over different TRPs);

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of an example process in a wireless device according to some embodiments of the present disclosure;

FIG. 14 is a flowchart of an example process in a network node according to some embodiments of the present disclosure;

FIG. 15 is a flowchart of an example process in a wireless device according to some embodiments of the present disclosure;

FIG. 16 is an example of BFD resource determination with single BFD resource set when CORESET is configured for SFN-based PDCCH diversity according to some embodiments of the present disclosure;

FIG. 17 is a second example of BFD resource determination with single BFD resource set when CORESET is configured for SFN-based PDCCH diversity according to some embodiments of the present disclosure;

FIG. 18 is a third example of BFD resource determination with single BFD resource set when CORESET is configured for SFN-based PDCCH diversity according to some embodiments of the present disclosure;

FIG. 19 is an example of BFD resource determination with two BFD resource sets (e.g., one per TRP) when CORESET is configured for SFN-based PDCCH diversity according to some embodiments of the present disclosure;

FIG. 20 is an example of BFD resource determination with single BFD resource set when two CORESET are configured for non-SFN-based PDCCH repetition according to some embodiments of the present disclosure;

FIG. 21 is a second example of BFD resource determination with single BFD resource set when two CORESET are configured for non-SFN-based PDCCH repetition according to some embodiments of the present disclosure;

FIG. 22 is a third example of BFD resource determination with single BFD resource set when two CORESETs are configured for non-SFN-based PDCCH repetition according to some embodiments of the present disclosure; and

FIG. 23 is an example of BFD resource determination with two BFD resource sets when two CORESETs are configured for non-SFN-based PDCCH repetition according to some embodiments of the present disclosure.

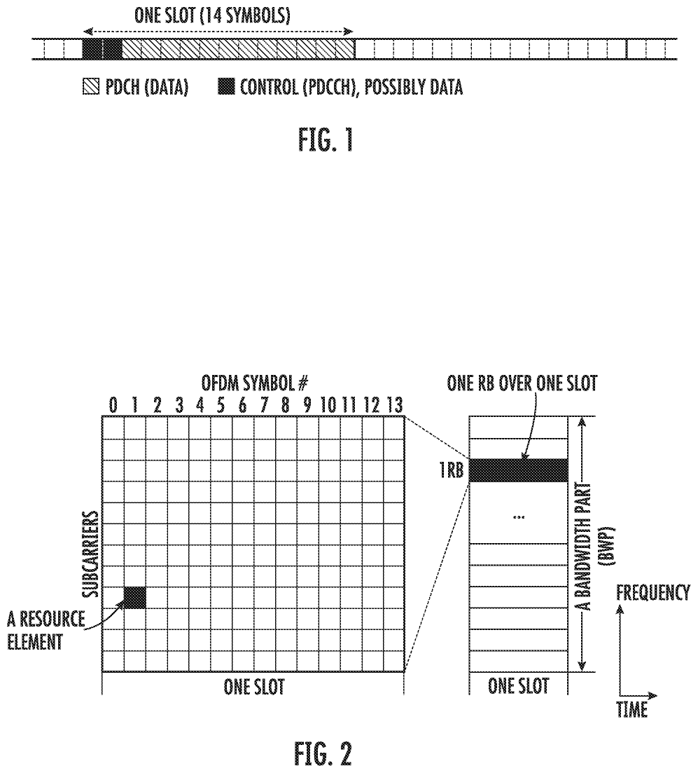

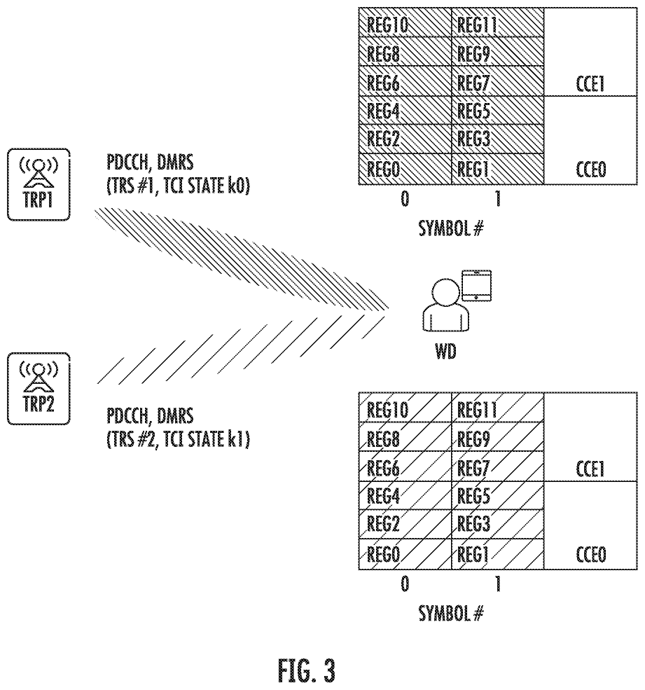

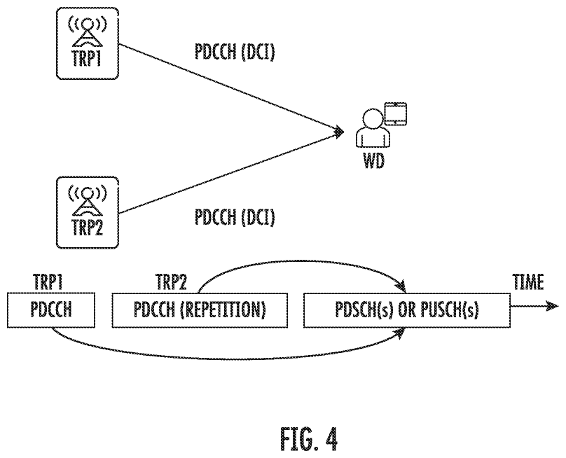

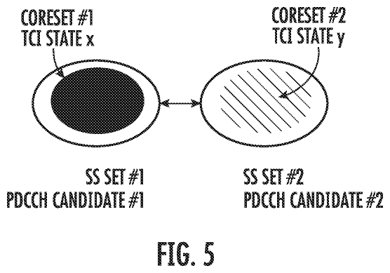

### DETAILED DESCRIPTION

In the existing NR standard, when beam failure detection resources are determined implicitly, the WD determines the resources in the set q̅₀ are determined from the TCI stated activated for the respective CORESETs. However, in NR Rel-15/16, only a single TCI state can be activated per CORESET. For the Rel-17 SFN-based PDCCH diversity scheme considered recently in 3GPP RAN1, a CORESET can be activated with 2 TCI states. Hence, how beam failure detection resources are determined when a CORESET is activated with two TCI states is an open problem.

In the case of non-SFN based PDCCH repetition to be supported in NR Rel-17, the PDCCH is repeated over two different TRPs via two linked PDCCH candidates in two different search space sets in two different CORESETs. The different CORESETs are activated with different TCI states (i.e., one TCI state activated per each CORESET). How beam failure detection resources are determined when a WD is configured with two linked CORESETs (for the purpose of PDCCH repetition) is another open problem.

Some embodiments of the present disclosure provide proposed solutions for beam failure detection resource determination:
for SFN-PDCCH scheme where two TCI states are activated per CORESET; and
for PDCCH repetition scheme where two TCI states are activated for two linked CORESETs.

Some embodiments may advantageously provide solutions to provide enable BFD resource determination when two TCI states are activated per CORESET for SFN-based PDCCH reception. Some embodiments may enable BFD resource determination when two TCI states are activated for two linked CORESETs (for the purpose of PDCCH repetition).Some proposed solutions also enable BFD resource determination in a multi-TRP scenario.

Before describing in detail example embodiments, it is noted that the embodiments reside primarily in combinations of apparatus components and processing steps related to beam failure detection for single-DCI based multi-TRP schemes. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of TRP, base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

The “network node” may comprise one or more TRPs. In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states. In some embodiments, a TRP may a part of the gNB transmitting and receiving radio signals to/from WD according to physical layer properties and parameters inherent to that element. In some embodiments, in Multiple Transmit/Receive Point (multi-TRP) operation, a serving cell can schedule WD from two TRPs, providing better PDSCH coverage, reliability and/or data rates. There are two different operation modes for multi-TRP: single-DCI and multi-DCI. For both modes, control of uplink and downlink operation is done by both physical layer and MAC. In single-DCI mode, WD is scheduled by the same DCI for both TRPs and in multi-DCI mode, WD is scheduled by independent DCIs from each TRP.

Some embodiments of the present disclosure may use the term “TRP” or more generally “network node” to explain the example embodiments; however, it should be understood that the TRPs and network nodes described in the various embodiments may be any of what is described above as being an example of a TRP and/or a network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD. Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

The term “signaling” used herein may comprise any of: high-layer signaling (e.g., via Radio Resource Control (RRC) or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node. Signaling may generally comprise one or more symbols and/or signals and/or messages. A signal may comprise or represent one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes. Signaling associated to a channel may be transmitted such that represents signaling and/or information for that channel, and/or that the signaling is interpreted by the transmitter and/or receiver to belong to that channel. Such signaling may generally comply with transmission parameters and/or format/s for the channel.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices corresponding to a table, and/or one or more bit patterns representing the information.

Transmitting in downlink may pertain to transmission from the network or network node to the terminal. The terminal may be considered the WD or UE. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

### Configuring a Radio Node

Configuring a radio node, in particular a terminal or user equipment or the WD, may refer to the radio node being adapted or caused or set and/or instructed to operate according to the configuration. Configuring may be done by another device, e.g., a network node (for example, a radio node of the network like a base station or gNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources, or e.g., configuration for performing certain measurements on certain subframes or radio resources. A radio node may configure itself, e.g., based on configuration data received from a network or network node. A network node may use, and/or be adapted to use, its circuitry/ies for configuring. Allocation information may be considered a form of configuration data. Configuration data may comprise and/or be represented by configuration information, and/or one or more corresponding indications and/or message/s.

### Configuring in General

Generally, configuring may include determining configuration data representing the configuration and providing, e.g., transmitting, it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal (e.g. WD) may comprise scheduling downlink and/or uplink transmissions for the terminal, e.g. downlink data and/or downlink control signaling and/or DCI and/or uplink control or data or communication signaling, in particular acknowledgement signaling, and/or configuring resources and/or a resource pool therefor. In particular, configuring a terminal (e.g. WD) may comprise configuring the WD to perform certain measurements on certain subframes or radio resources and reporting such measurements according to embodiments of the present disclosure.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g., by the network or a network node.

In some embodiments, a “set” as used herein may be a set of 1 or more elements in the set.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

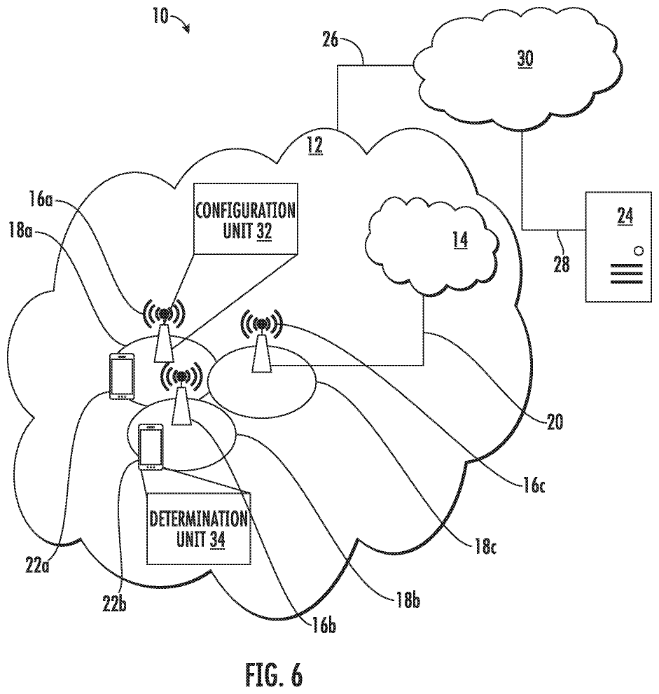

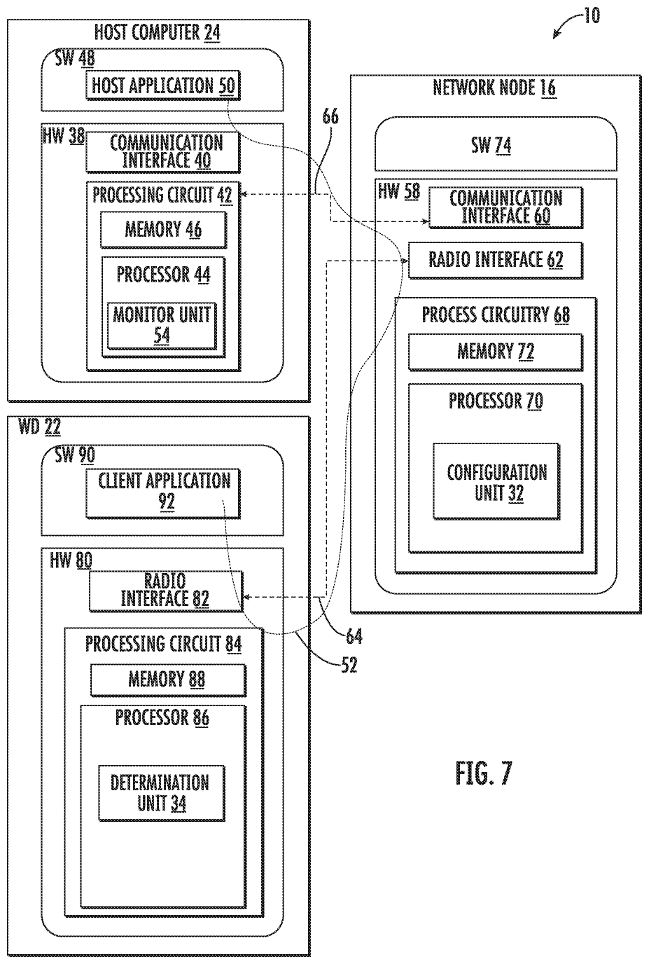

Some embodiments provide arrangements for beam failure detection for single-DCI based multi-TRP schemes. Referring again to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to configure at least one control resource set (CORESET) and activate at least transmission configuration (TCI) state; determine at least one reference signal (RS) as a quasi-colocation (QCL) type D source RS in the at least one TCI state for the at least one CORESET as at least one beam failure detection RS (BFD-RS); and include the determined at least one BFD-RS in at least one beam failure resource set.

A wireless device 22 is configured to include a determination unit 34 which is configured to receive a configuration of at least one control resource set (CORESET) and an activation of at least transmission configuration (TCI) state; and determine at least one beam failure detection reference signal (BFD-RS) in at least one beam failure resource set. In some embodiments, the determination unit 34 is configured to determine at least one beam failure detection reference signal, BFD-RS, in at least one beam failure detection resource set, each of the at least one BFD-RS being a quasi-colocation, QCL, Type D source RS in at least one of the at least two activated TCI states for at least one of the at least one CORESET.

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and/or the wireless device 22. The processing circuitry 42 of the host computer 24 may include a monitor unit 54 configured to enable the service provider to observe, monitor, control, transmit to and/or receive from the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

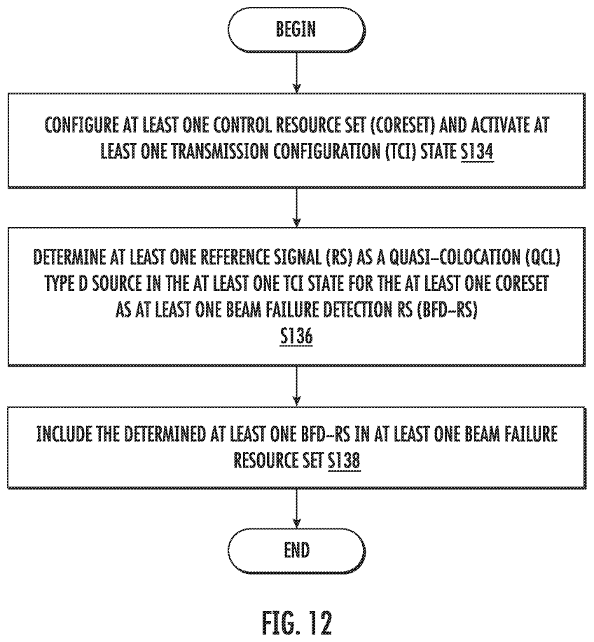

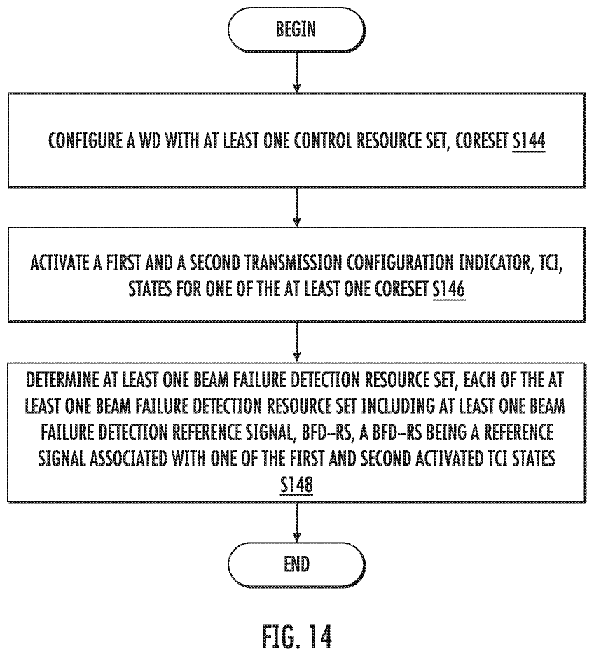

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include configuration unit 32 configured to perform network node methods discussed herein, such as the methods discussed with reference to FIGS. 12 and 14, as well as other figures.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

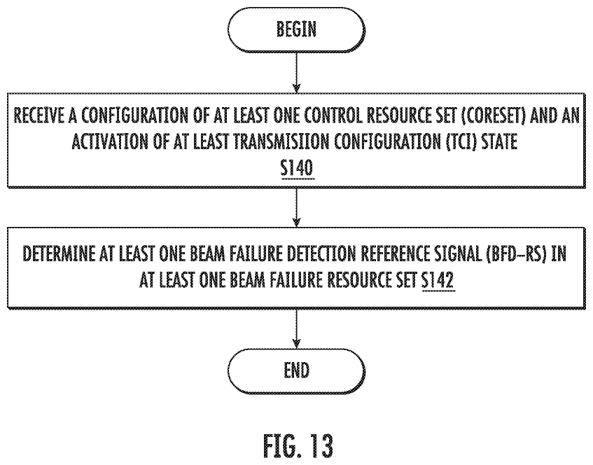

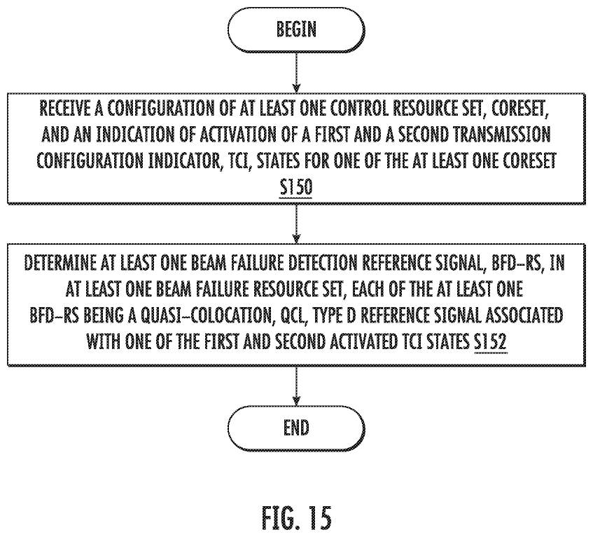

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a determination unit 34 configured to perform WD methods discussed herein, such as the methods discussed with reference to FIGS. 13 and 15, as well as other figures.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and determination unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

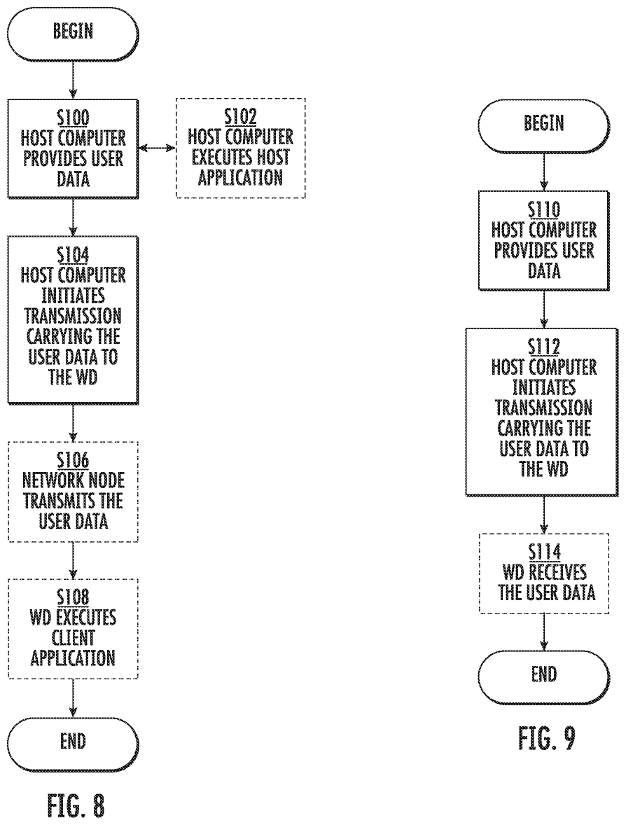

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

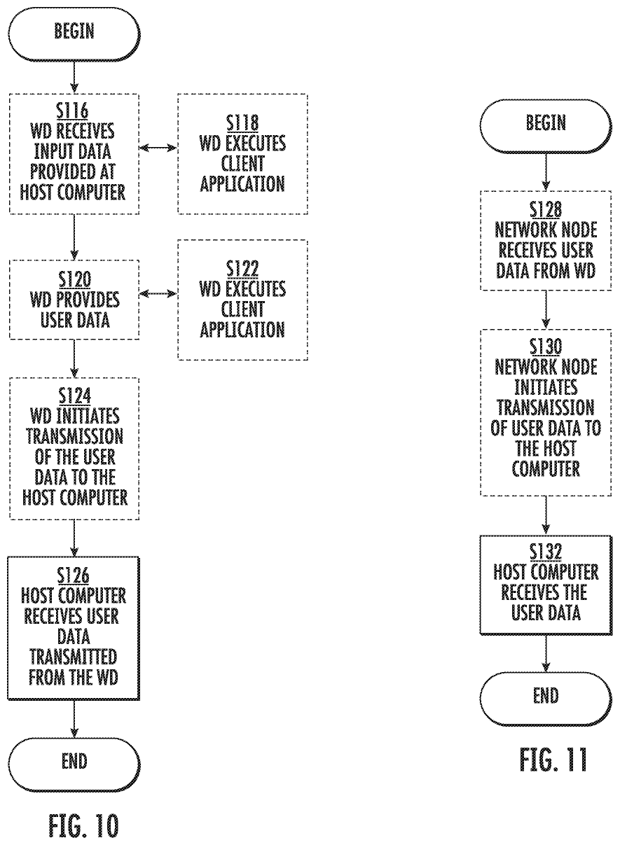

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

FIG. 12 is a flowchart of an example process in a network node 16 according to some embodiments of the present disclosure. One or more Blocks and/or functions and/or methods performed by the network node 16 may be performed by one or more elements of network node 16 such as by configuration unit 32 in processing circuitry 68, processor 70, radio interface 62, etc. according to the example method. The example method includes configuring (Block S134), such as via configuration unit 32, processing circuitry 68, processor 70 and/or radio interface 62, at least one control resource set (CORESET) and activate at least one transmission configuration (TCI) state. The method includes determining (Block S136), such as via configuration unit 32, processing circuitry 68, processor 70 and/or radio interface 62, at least one reference signal (RS) as a quasi-colocation (QCL) type D source reference signal in the at least one TCI state for the at least one CORESET as at least one beam failure detection RS (BFD-RS). The method includes including (Block S138), such as via configuration unit 32, processing circuitry 68, processor 70 and/or radio interface 62, the determined at least one BFD-RS in at least one beam failure detection resource set. In some embodiments, only some of these steps are performed by a network node 16. In some of these embodiments, results associated with steps not performed by the network node 16 are either performed elsewhere and derived and/or obtained by the network node 16 in a different manner, or they may be replaced by alternate steps.

In some embodiments, the configuring, the activating and the including further include one or more of: configuring, such as via configuration unit 32, processing circuitry 68, processor 70 and/or radio interface 62, one CORESET and activating two TCI states via a medium access control (MAC) control element (CE); and including, such as via configuration unit 32, processing circuitry 68, processor 70 and/or radio interface 62, the determined at least BFD-RS in a first beam failure detection resource set and a second beam failure detection resource set, the first beam failure detection resource set corresponding to a first transmission reception point (TRP) and the second beam failure detection resource set corresponding to a second TRP.

In some embodiments, the configuring, the activating and the including further comprise one or more of: configuring, such as via configuration unit 32, processing circuitry 68, processor 70 and/or radio interface 62, two CORESETs and activating one TCI state via a medium access control (MAC) control element (CE) for each of the two CORESETs; and including, such as via configuration unit 32, processing circuitry 68, processor 70 and/or radio interface 62, the determined at least one BFD-RS in a single beam failure detection resource set.

FIG. 13 is a flowchart of an example process in a wireless device 22 according to some embodiments of the present disclosure. One or more Blocks and/or functions and/or methods performed by WD 22 may be performed by one or more elements of WD 22 such as by determination unit 34 in processing circuitry 84, processor 86, radio interface 82, etc. The example method includes receiving (Block S140), such as via determination unit 34, processing circuitry 84, processor 86 and/or radio interface 82, a configuration of at least one control resource set (CORESET) and an activation of at least one transmission configuration (TCI) state. The method includes determining (Block S142), such as via determination unit 34, processing circuitry 84, processor 86 and/or radio interface 82, at least one beam failure detection reference signal (BFD-RS) in at least one beam failure detection resource set. In some of these embodiments, results associated with steps not performed by the WD 22 are either performed elsewhere and derived and/or obtained by the WD 22 in a different manner, or they may be replaced by alternate steps.

In some embodiments, receiving the configuration, receiving the activation and determining further comprise one or more of: receiving, such as via determination unit 34, processing circuitry 84, processor 86 and/or radio interface 82, the configuration of one CORESET and the activation of two TCI states via a medium access control (MAC) control element (CE) for the CORESET; and determining, such as via determination unit 34, processing circuitry 84, processor 86 and/or radio interface 82, at least one BFD-RS in a first beam failure detection resource set and a second beam failure detection resource set, the first beam failure detection resource set corresponding to a first transmission reception point (TRP) and the second beam failure detection resource set corresponding to a second TRP.

In some embodiments, receiving the configuration, receiving the activation and determining further comprise one or more of: receiving, such as via determination unit 34, processing circuitry 84, processor 86 and/or radio interface 82, the configuration of two CORESETs and the activation of one TCI state via a medium access control (MAC) control element (CE) for each of the two CORESETs; and determining, such as via determination unit 34, processing circuitry 84, processor 86 and/or radio interface 82, at least one BFD-RS in a single beam failure detection resource set.

FIG. 14 is a flowchart of another example process in a network node 16 according to some embodiments of the present disclosure. One or more Blocks and/or functions and/or methods performed by the network node 16 may be performed by one or more elements of network node 16 such as by configuration unit 32 in processing circuitry 68, processor 70, radio interface 62, etc. according to the example method. The example method includes: configuring the WD with at least one control resource set, CORESET (Block S144); activating a first and a second transmission configuration indicator, TCI, state for one of the at least one CORESET (Block S146); and determining at least one beam failure detection resource set, each of the at least one beam failure detection resource set including at least one beam failure detection reference signal, BFD-RS, a BFD-RS being a reference signal associated with one of the first and second activated TCI states (Block S148).

In some embodiments, the reference signal associated with one of the first and second activated TCI states is a quasi-colocation, QCL, Type D reference signal. In some embodiments, the at least one beam failure detection resource set comprises a single beam failure detection resource set including a first BFD-RS being a reference signal associated with the first activated TCI state and a second BFD-RS being a reference signal associated with the second activated TCI state. In some embodiments, the at least one CORESET comprises a second CORESET activated with a third activated TCI state, and a single beam failure detection resource set includes a third BFD-RS being a reference signal associated with the third activated TCI state. In some embodiments, the at least one CORESET comprises a second CORESET activated with a third activated TCI state and a forth activated TCI state, and a single beam failure detection resource set includes a third BFD-RS being a reference signal associated with the third activated TCI state and a fourth BFD-RS being a reference signal associated with the fourth activated TCI state. In some embodiments, the reference signal associated with one of the third and fourth activated TCI states is a quasi-colocation, QCL, Type D reference signal. In some embodiments, a first beam failure detection resource set comprises a reference signal of QCL Type D associated with the first activated TCI state. In some embodiments, a second beam failure detection resource set comprises a reference signal of QCL type D associated with the second activated TCI state. In some embodiments, configuring at least one CORESET includes configuring two linked CORESETs and activating a TCI state for each of the two linked CORESETS. In some embodiments, determining at least one beam failure detection resource set includes reference signals associated with the activated TCI states for both of the two linked CORESETs.

FIG. 15 is a flowchart of an example process in a wireless device 22 according to some embodiments of the present disclosure. One or more Blocks and/or functions and/or methods performed by WD 22 may be performed by one or more elements of WD 22 such as by determination unit 34 in processing circuitry 84, processor 86, radio interface 82, etc. The example method includes: receiving a configuration of at least one control resource set, CORESET, and an indication of activation of a first and a second transmission configuration indicator, TCI, states for one of the at least one CORESET (Block S150); and determining at least one beam failure detection reference signal, BFD-RS, in at least one beam failure detection resource set, each of the at least one BFD-RS being a quasi-colocation, QCL, Type D reference signal associated with one of the first and second activated TCI states (S152).

According to this aspect, in some embodiments, the reference signal associated with one of the first and second activated TCI states is a quasi-colocation, QCL, Type D reference signal. In some embodiments, the at least one beam failure detection resource set comprise a single beam failure detection resource set including a first BFD-RS being a reference signal associated with the first activated TCI states and a second BFD-RS being a reference signal associated with the second activated TCI state. In some embodiments, the configuration of at least one CORESET includes a configuration of two linked CORESETs and an indication of an activated TCI state for each of the two linked CORESETs.

Having described the general process flow of arrangements of the disclosure and having provided examples of hardware and software arrangements for implementing the processes and functions of the disclosure, the sections below provide details and examples of arrangements for beam failure detection for single-DCI based multi-TRP schemes that may be implemented by the network node 16, wireless device 22 and/or host computer 24.

Embodiment 1: BFD Resource Determination when CORESET is Configured for SFN-based PDCCH Diversity—Single BFD Resource Set

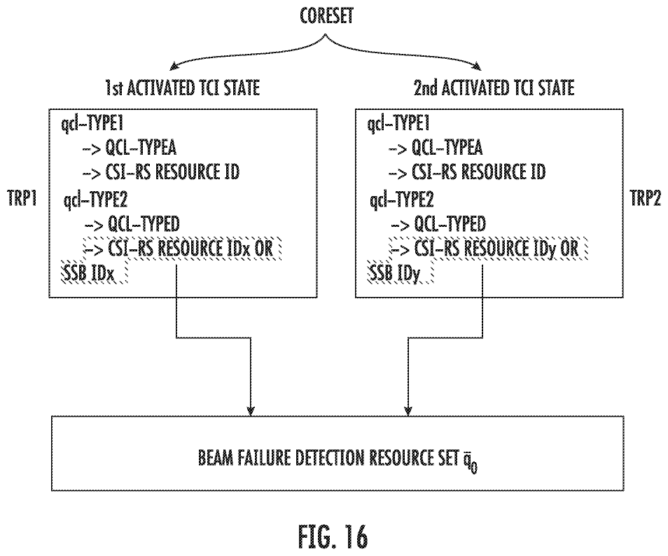

In one embodiment, a CORESET is activated (e.g., via a MAC CE, sent by e.g., network node 16 to WD 22) with two TCI states wherein each active TCI state contains a QCL-TypeD source RS as shown in FIG. 16. If no SSB/CSI-RS are configured as beam failure detection reference signals (i.e., beam failure detection reference signals are not explicitly configured, e.g., by the network node/NN 16 to e.g., the WD 22), then the WD 22 may assume that the reference signals used as QCL-Type D source reference signals in the two activated TCI states for the CORESET are used as beam detection reference signals. In the example of FIG. 16, a QCL-Type D source reference signal with CSI-RS resource IDx (or SSB IDx) corresponding to the 1st activated TCI state and a QCL-Type D source reference signal with CSI-RS resource IDy (or SSB IDy) corresponding to the 2nd activated TCI state may be included by the WD 22 in the beam failure detection resource set. In some embodiments, the beam failure detection resource set may include additional QCL-Type D source reference signal corresponding to TCI states activated in other CORESETs (i.e., other CORESETs in the same bandwidth part and serving cell as the CORESET shown in FIG. 16). Here, the first and second activated TCI states are identified as the first and second TCI states activated by the MAC CE, respectively. In an alternative embodiment, the first and second activated TCI states are the TCI states activated for the CORESET that has the lowest TCI state ID and the highest TCI state ID.

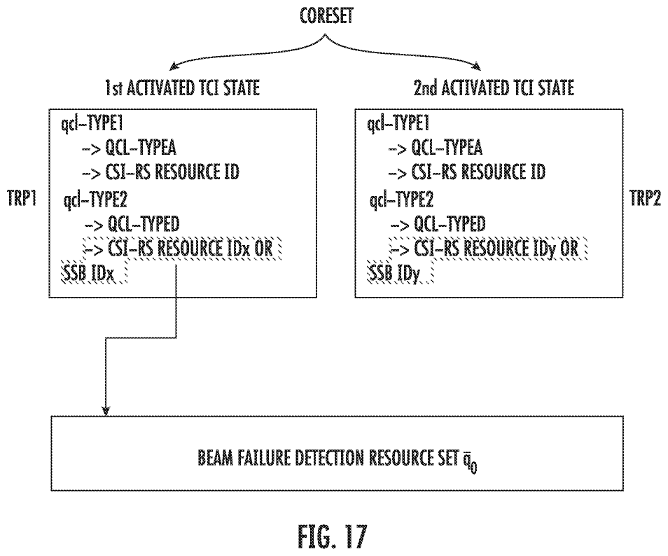

In another embodiment, a CORESET is activated (e.g., via a MAC CE, sent by e.g., network node 16 to WD 22) with two TCI states wherein each active TCI state contains a QCL-TypeD source RS as shown in FIG. 17. If no SSB/CSI-RS are configured as beam failure detection reference signals (i.e., beam failure detection reference signals are not explicitly configured), then the WD 22 may assume that the reference signal used as the QCL-Type D source reference signal in the first activated TCI state for the CORESET is used as a beam detection reference signal. In the example of FIG. 17, a QCL-Type D source reference signal with CSI-RS resource IDx (or SSB IDx) corresponding to the 1^{st} activated TCI state may be included by the WD 22 in the beam failure detection resource set q̅₀. In some embodiments, the beam failure detection resource set q̅₀ may include additional QCL-Type D source reference signal corresponding to TCI states activated in other CORESETs (i.e., other CORESETs in the same bandwidth part and serving cell as the CORESET shown in FIG. 17). Here, the first activated TCI state is identified as the first TCI state activated by the MAC CE. In an alternative embodiment, the first activated TCI state is the TCI state activated for the CORESET that has the lowest TCI state ID.

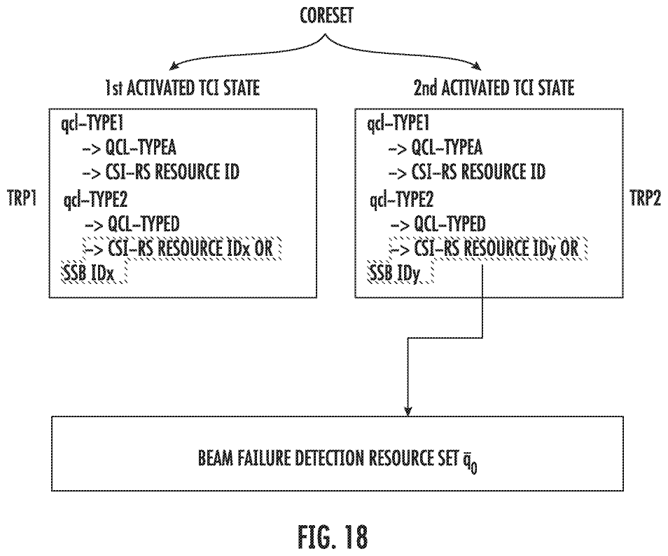

In yet another embodiment, a CORESET is activated (e.g., via a MAC CE, sent by e.g., network node 16 to WD 22) with two TCI states, where each active TCI state contains a QCL-TypeD source RS as shown in FIG. 18. If no SSB/CSI-RS are configured as beam failure detection reference signals (i.e., beam failure detection reference signals are not explicitly configured), then the WD 22 may assume that the reference signal used as the QCL-Type D source reference signal in the second activated TCI state for the CORESET is used as a beam detection reference signal. In the example of FIG. 18, the QCL-Type D source reference signal with CSI-RS resource IDy (or SSB IDy) corresponding to the 2^{nd} activated TCI state may be included by the WD 22 in the beam failure detection resource set q̅₀. In some embodiments, the beam failure detection resource set q̅₀ may include additional a QCL-Type D source reference signal corresponding to TCI states activated in other

CORESETs (i.e., other CORESETs in the same bandwidth part and serving cell as the CORESET shown in FIG. 18). Here, the second activated TCI state is identified as the second TCI state activated by the MAC CE. In an alternative embodiment, the second activated TCI state is the TCI state activated for the CORESET that has the highest TCI state ID.

In yet another embodiment, when a MAC CE (e.g., transmitted by NN 16 to WD 22) activates the two TCI states for a CORESET, multiple fields in the MAC CE explicitly indicate which TCI states should be considered when determining beam failure detection resources. Denote the two activated TCI states via the corresponding IDs, TCI state IDₓ and TCI state ID_{y} which are indicated as part of the MAC CE. Then, fields Cₓ and C_{y} indicate if the QCL-TypeD sources associated with TCI state IDₓ and/or TCI state ID_{y} should be included when determining beam failure detection resources in the set q̅₀.

### Embodiment 2: BFD Resource Determination when CORESET is Configured for SFN-based PDCCH Diversity—Multiple BFD Resource Set (One BFD Resource Set per TRP)

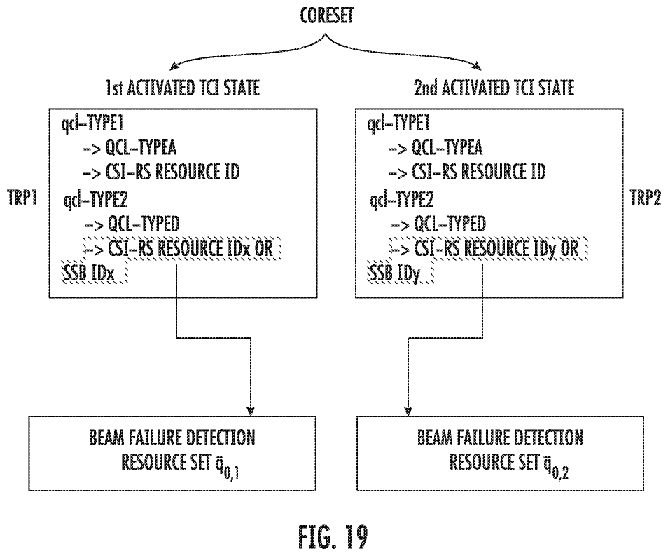

In some embodiments, a CORESET is activated (e.g., via a MAC CE e.g., transmitted by NN 16 to WD 22) with two TCI states, where each active TCI state contains a QCL-TypeD source RS, as shown in FIG. 19. If no SSB/CSI-RS are configured as beam failure detection reference signals (i.e., beam failure detection reference signals are not explicitly configured by NN 16), then the WD 22 may assume that the reference signal used as a QCL-Type D source reference signal in the first activated TCI state for the CORESET is used as a beam detection reference signal in a first beam failure detection resource set. Similarly, the WD 22 may assume that the reference signal used as QCL-Type D source reference signal in the second activated TCI state for the CORESET is used as a beam detection reference signal in a second beam failure detection resource set.

In the example of FIG. 19, the QCL-Type D source reference signal with CSI-RS resource IDx (or SSB IDx) corresponding to the 1^{st} activated TCI state may be included by the WD 22 in the beam failure detection resource set q̅_{0,1}. The QCL-Type D source reference signal with CSI-RS resource IDy (or SSB IDy) corresponding to the 2^{nd} activated TCI state may be included by the WD 22 in the beam failure detection resource set q̅_{0,2}.

In some embodiments, the beam failure detection resource set q̅_{0,1} may include additional QCL-Type D source reference signals corresponding to TCI states associated to TRP1 that are activated in other CORESETs in the same bandwidth part and serving cell as the CORESET shown in FIG. 19. Similarly, the beam failure detection resource set q̅_{0,2} may include additional QCL-Type D source reference signals corresponding to TCI states associated to TRP2 that are activated in other CORESETs in the same bandwidth part and serving cell as the CORESET shown in FIG. 19.

Here, the first and second activated TCI states are identified as the first and second TCI states activated by the MAC CE, respectively. In some embodiments, the first and second activated TCI states are the TCI states activated for the CORESET that has the lowest TCI state ID and the highest TCI state ID.

In some embodiments, when a MAC CE (e.g., transmitted by NN 16 to WD 22) activates the two TCI states for a CORESET, multiple fields in the MAC CE explicitly indicate which TCI states should be considered when determining beam failure detection resources in different beam failure detection resource sets. Denote the two activated TCI states via the corresponding IDs, TCI state IDx and TCI state IDy which are indicated as part of the MAC CE. Then, fields Cx and Cy indicate if the QCL-TypeD sources associated with TCI state IDx and/or TCI state IDy should be included when determining beam failure detection resources in set q̅_{0,1} or q̅_{0,2}.

In some embodiments, a value of Cx=0 indicates that the QCL-TypeD source associated with TCI state IDx should be included when determining beam failure detection resource in set q̅_{0,1}. In some embodiments, a value of Cx=1 indicates that the QCL-TypeD source associated with TCI state IDx should be included when determining beam failure detection resource in set q̅_{0,2}.

In some embodiments, a value of Cy=0 indicates that the QCL-TypeD source associated with TCI state IDy should be included when determining beam failure detection resource in set q̅_{0,1}. A value of Cy=1 indicates that the QCL-TypeD source associated with TCI state IDy should be included when determining beam failure detection resource in set q̅_{0,2}.

### Embodiment 3: BFD Resource Determination when Linked CORESETs are Configured for Non-SFN-based PDCCH Repetition—Single BFD Resource Set

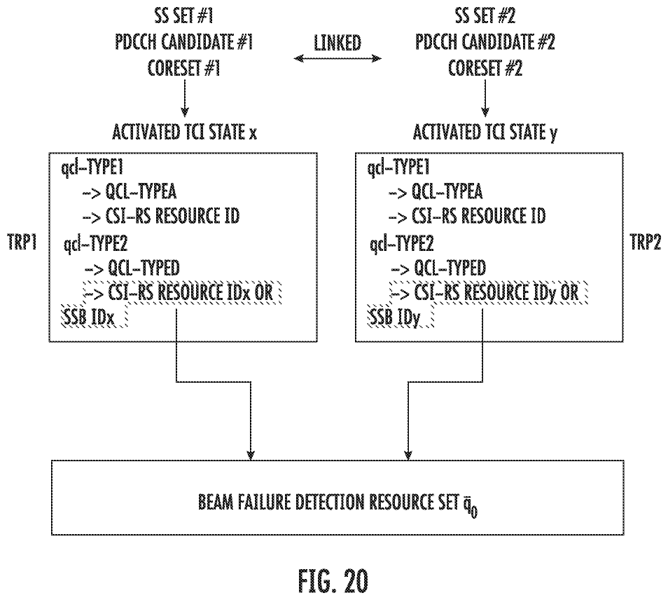

In some embodiments, linked PDCCH candidates each associated with one of two TRPs are in different search space sets associated with different CORESETs, as demonstrated in FIG. 20. If no SSB/CSI-RS are configured by NN 16 as beam failure detection reference signals (i.e., beam failure detection reference signals are not explicitly configured), then the WD 22 may assume that the reference signals used as QCL-Type D source reference signals in activated TCI states x and y (in CORESET#1 and CORESET#2, respectively) are used as beam detection reference signals.

In the example of FIG. 20, the QCL-Type D source reference signal with CSI-RS resource IDx (or SSB IDx) corresponding to activated TCI state x (for CORESET #1), and the QCL-Type D source reference signal with CSI-RS resource IDy (or SSB IDy) corresponding to activated TCI state y (for CORESET #2), may be included by the WD 22 in the beam failure detection resource set q̅₀. In some embodiments, the beam failure detection resource set q̅₀ may include additional QCL-Type D source reference signal corresponding to TCI states activated in other CORESETs (in the same bandwidth part and serving cell as CORESETs #1 and #2 shown in FIG. 20.

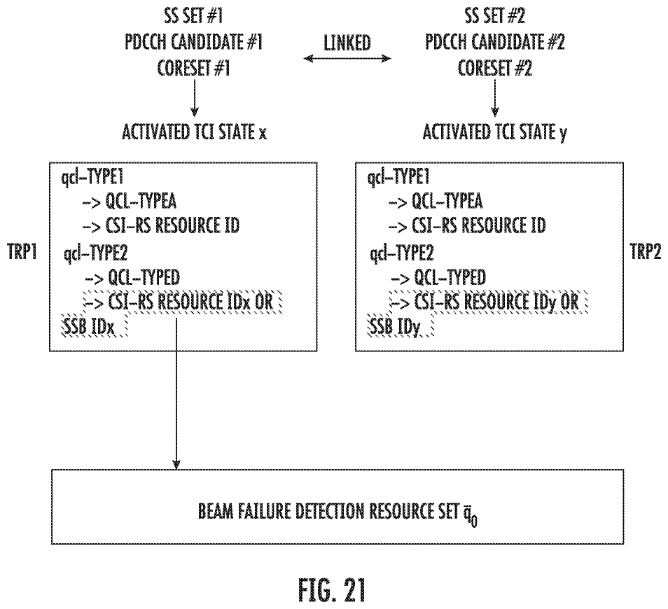

In some embodiments, linked PDCCH candidates each associated with one of two TRPs are in different search space sets associated with different CORESETs as demonstrated in FIG. 21. If no SSB/CSI-RS are configured by NN 16 as beam failure detection reference signals (i.e., beam failure detection reference signals are not explicitly configured), then the WD 22 may assume that the reference signals used as QCL-Type D source reference signals in activated TCI state x (in the first linked CORESET#1) are used as beam detection reference signals. In some embodiments, the first linked CORESET may be defined as the CORESET with the lowest CORESET ID among the two linked CORESETs. In the example of FIG. 21, a QCL-Type D source reference signal with CSI-RS resource IDx (or SSB IDx) corresponding to activated TCI state x (for CORESET #1) is to be included by the WD 22 in the beam failure detection resource set q̅₀. In some embodiments, the beam failure detection resource set q̅₀ may include additional QCL-Type D source reference signal corresponding to TCI states activated in other CORESETs in the same bandwidth part and serving cell as CORESET #1 shown in FIG. 21).

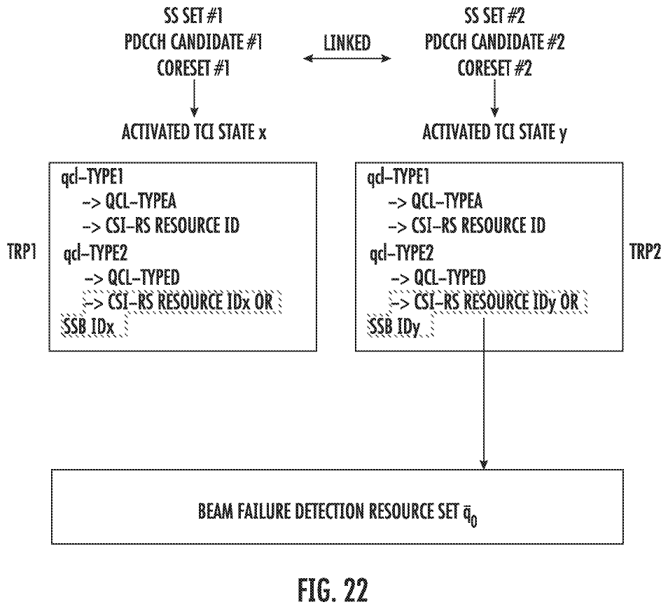

In some embodiments, linked PDCCH candidates, each PDCCH candidate associated with one of two TRPs, are in different search space sets associated with different CORESETs, as demonstrated in FIG. 22. If no SSB/CSI-RS are configured as beam failure detection reference signals (i.e., beam failure detection reference signals are not explicitly configured by NN 16), then the WD 22 may assume that the reference signal used as the QCL-Type D source reference signal in activated TCI state y (in the last linked CORESET#1) is used as beam detection reference signals. In some embodiments, the last linked CORESET may be defined as the CORESET with the highest CORESET ID among the two linked CORESETs. In the example of FIG. 22, a QCL-Type D source reference signal with CSI-RS resource IDy (or SSB IDy) corresponding to activated TCI state y (for CORESET #2) may be included by the WD 22 in the beam failure detection resource set q̅₀. In some embodiments, the beam failure detection resource set q̅₀ may include additional QCL-Type D source reference signals corresponding to TCI states activated in other CORESETs in the same bandwidth part and serving cell as CORESET #2 shown in FIG. 22.

### Embodiment 4: BFD Resource Determination when Linked CORESETs are Configured for Non-SFN-based PDCCH Repetition—Multiple BFD Resource Set (One BFD Resource Set per TRP)

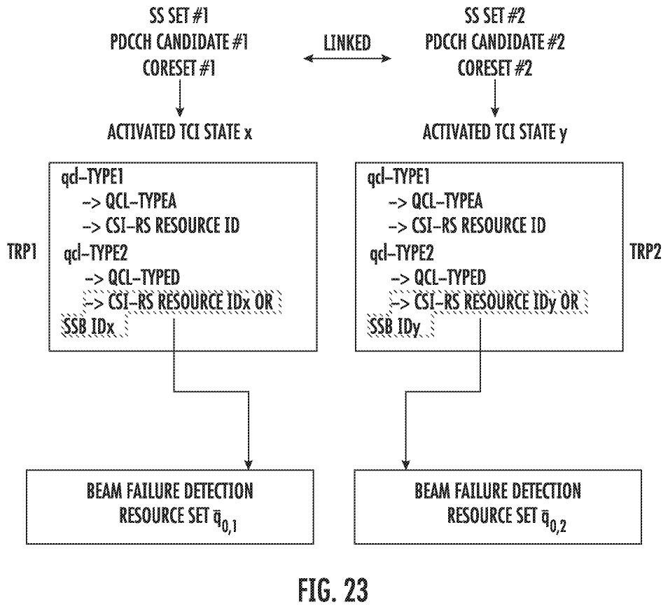

In this embodiment, linked PDCCH candidates, each PDCCH candidate associated with one of two TRPs, are in different search space sets associated with different CORESETs, as shown in the example diagram of FIG. 23.

If no SSB/CSI-RS are configured as beam failure detection reference signals (i.e., beam failure detection reference signals are not explicitly configured by NN 16), then the WD 22 may assume that the reference signal used as QCL-Type D source reference signal in activated TCI state x (in the first linked CORESET#1) is used as the beam detection reference signal in a first beam failure detection resource set. In some embodiments, the first linked CORESET may be defined as the CORESET with the lowest CORESET ID among the two linked CORESETs. In the example of FIG. 23, the QCL-Type D source reference signal with CSI-RS resource IDx (or SSB IDx) corresponding to activated TCI state x may be included by the WD 22 in the beam failure detection resource set q̅_{0,1}.

Similarly, the WD 22 may assume that the reference signal used as QCL-Type D source reference signal in activated TCI state y (in the last linked CORESET #2) is used as beam detection reference signal in a second beam failure detection resource set. In some embodiments, the last linked CORESET may be defined as the CORESET with the largest CORESET ID among the two linked CORESETs. In the example of FIG. 23, the QCL-Type D source reference signal with CSI-RS resource IDy (or SSB IDy) corresponding to activated TCI state y may be included by the WD 22 in the beam failure detection resource set q̅_{0,2}.

Some more example embodiments are described below. One or more of the following example methods may be implemented by network node 16 and/or WD 22 and/or host computer 24.

### Embodiment 1

1. Method beam failure detection resource determination the method comprising one or more of:
   a. configuring a CORESET and activating two TCI states via MAC CE;
   b. determining the reference signal(s) used as QCL-Type D source reference signals in at least one of the two activated TCI states for the CORESET as beam failure detection reference signals;
   c. including the determined beam failure detection reference signals in a single beam failure detection resource set;
2. The method of 1 (of Embodiment 1) where reference signal(s) used as QCL-Type D source reference signals in both of the two activated TCI states for the CORESET are determined as beam failure detection reference signals;
3. The method of 1 (of Embodiment 1) where reference signal(s) used as QCL-Type D source reference signals in the first of the two activated TCI states for the CORESET is determined as beam failure detection reference signals;
4. The method of 1 (of Embodiment 1) where reference signal(s) used as QCL-Type D source reference signals in the second of the two activated TCI states for the CORESET is determined as beam failure detection reference signals;
5. The method of any of 1-4 (of Embodiment 1), where beam failure detection reference signals in the single beam failure detection resource set are used for detecting beam failure by the WD 22.

### Embodiment 2

1. Method beam failure detection resource determination the method comprising one or more of:
   a. configuring a CORESET and activating two TCI states via MAC CE;
   b. determining the reference signal(s) used as QCL-Type D source reference signals in at least one of the two activated TCI states for the CORESET as beam failure detection reference signals;
   c. including the determined beam failure detection reference signals in two different beam failure detection resource sets corresponding to a first TRP and a second TRP;
2. The method of 1 (of Embodiment 2) where reference signal(s) used as QCL-Type D source reference signals in the first of the two activated TCI states for the CORESET is determined as beam failure detection reference signal and included in the first beam failure detection resource set;
3. The method of 1 (of Embodiment 2) where reference signal(s) used as QCL-Type D source reference signals in the second of the two activated TCI states for the CORESET is determined as beam failure detection reference signal and included in the second beam failure detection resource set;
4. The method of any of 1-3 (of Embodiment 2), where beam failure detection reference signals in the first beam failure detection resource set are used for detecting beam failure corresponding to a first TRP by the WD 22;
5. The method of any of 1-3 (of Embodiment 2), where beam failure detection reference signals in the second beam failure detection resource set are used for detecting beam failure corresponding to a second TRP by the WD 22.

### Embodiment 3

1. Method beam failure detection resource determination the method comprising one or more of:
   a. configuring two linked CORESETs and activating one TCI state via MAC CE for each CORESET;
   b. determining the reference signal(s) used as QCL-Type D source reference signals in at least one of the two activated TCI states corresponding to the two linked CORESET as beam failure detection reference signals;
   c. including the determined beam failure detection reference signals in a single beam failure detection resource set;
2. The method of 1 (of Embodiment 3) where reference signal(s) used as QCL-Type D source reference signals in both of the two activated TCI states for the two linked CORESETs are determined as beam failure detection reference signals;
3. The method of 1 (of Embodiment 3) where reference signal(s) used as QCL-Type D source reference signals in the first activated TCI state for the first of the two linked CORESETs is determined as beam failure detection reference signals;
4. The method of 1 (of Embodiment 3) where reference signal(s) used as QCL-Type D source reference signals in the second activated TCI state for the second of the two linked CORESETs is determined as beam failure detection reference signals;
5. The method of any of 1-4 (of Embodiment 3), where beam failure detection reference signals in the single beam failure detection resource set are used for detecting beam failure by the WD 22.

### Embodiment 4

1. Method beam failure detection resource determination the method comprising one or more of:
   a. configuring two linked CORESETs and activating one TCI state via MAC CE for each CORESET;
   b. determining the reference signal(s) used as QCL-Type D source reference signals in at least one of the two activated TCI states corresponding to the two linked CORESET as beam failure detection reference signals;
   c. including the determined beam failure detection reference signals in two different beam failure detection resource sets corresponding to a first TRP and a second TRP;
2. The method of 1 (of Embodiment 4) where reference signal(s) used as QCL-Type D source reference signals in the first activated TCI state for the first of the two linked CORESETs is determined as beam failure detection reference signals;
3. The method of 1 (of Embodiment 4) where reference signal(s) used as QCL-Type D source reference signals in the second activated TCI state for the second of the two linked CORESETs is determined as beam failure detection reference signals;
4. The method of any of 1-3 (of Embodiment 4), where beam failure detection reference signals in the first beam failure detection resource set are used for detecting beam failure corresponding to a first TRP by the WD 22;
5. The method of any of 1-3 (of Embodiment 4), where beam failure detection reference signals in the second beam failure detection resource set are used for detecting beam failure corresponding to a second TRP by the WD 22. Some further embodiments may include one or more of the following:

Embodiment A1. A network node configured to communicate with a wireless device (WD), the network node configured to, and/or comprising a radio interface and/or comprising processing circuitry configured to one or more of:
configure at least one control resource set (CORESET) and activate at least transmission configuration (TCI) state;
determine at least one reference signal (RS) as a quasi-colocation (QCL) type D source in the at least one TCI state for the at least one CORESET as at least one beam failure detection RS (BFD-RS); and
include the determined at least one BFD-RS in at least one beam failure resource set.

Embodiment A2. The network node of Embodiment A1, wherein the network node and/or radio interface and/or processing circuitry is configured to one or more of:
configure one CORESET and activate two TCI states via a medium access control (MAC) control element (CE); and
include the determined at least one BFD-RS in a first beam failure resource set and a second beam failure resource set, the first beam failure resource set corresponding to a first transmission reception point (TRP) and the second beam failure resource set corresponding to a second TRP.

Embodiment A3. The network node of Embodiment A1, wherein the network node and/or radio interface and/or processing circuitry is configured to one or more of:
configure two CORESETs and activate one TCI state via a medium access control (MAC) control element (CE) for each of the two CORESETs; and
include the determined at least one BFD-RS in a single beam failure resource set.

Embodiment B1. A method implemented in a network node, the method comprising to one or more of:
configuring at least one control resource set (CORESET) and activate at least transmission configuration (TCI) state;
determining at least one reference signal (RS) as a quasi-colocation (QCL) type D source in the at least one TCI state for the at least one CORESET as at least one beam failure detection RS (BFD-RS); and
including the determined at least one BFD-RS in at least one beam failure resource set.

Embodiment B2. The method of Embodiment B1, wherein the configuring, the activating and the including further comprising to one or more of:
configuring one CORESET and activating two TCI states via a medium access control (MAC) control element (CE); and
including the determined at least BFD-RS in a first beam failure resource set and a second beam failure resource set, the first beam failure resource set corresponding to a first transmission reception point (TRP) and the second beam failure resource set corresponding to a second TRP.

Embodiment B3. The method of Embodiment B1, wherein the configuring, the activating and the including further comprising to one or more of:
configuring two CORESETs and activating one TCI state via a medium access control (MAC) control element (CE) for each of the two CORESETs; and
including the determined at least one BFD-RS in a single beam failure resource set.

Embodiment C1. A wireless device (WD) configured to communicate with a network node, the WD configured to, and/or comprising a radio interface and/or processing circuitry configured to one or more of:
receive a configuration of at least one control resource set (CORESET) and an activation of at least transmission configuration (TCI) state; and
determine at least one beam failure detection reference signal (BFD-RS) in at least one beam failure resource set.

Embodiment C2. The WD of Embodiment C1, wherein the WD and/or radio interface and/or processing circuitry is configured to one or more of:
receive the configuration of one CORESET and the activation of two TCI states via a medium access control (MAC) control element (CE); and
determine at least one BFD-RS in a first beam failure resource set and a second beam failure resource set, the first beam failure resource set corresponding to a first transmission reception point (TRP) and the second beam failure resource set corresponding to a second TRP.

Embodiment C3. The WD of Embodiment C1, wherein the network node and/or radio interface and/or processing circuitry is configured to one or more of:
receive the configuration of two CORESETs and the activation of one TCI state via a medium access control (MAC) control element (CE) for each of the two CORESETs; and
determine at least one BFD-RS in a single beam failure resource set.

Embodiment D1. A method implemented in a wireless device (WD), the method comprising one or more of:
receiving a configuration of at least one control resource set (CORESET) and an activation of at least transmission configuration (TCI) state; and
determining at least one beam failure detection reference signal (BFD-RS) in at least one beam failure resource set.

Embodiment D2. The method of Embodiment D1, wherein receiving the configuration, receiving the activation and determining further comprises one or more of:
receiving the configuration of one CORESET and the activation of two TCI states via a medium access control (MAC) control element (CE); and
determining at least one BFD-RS in a first beam failure resource set and a second beam failure resource set, the first beam failure resource set corresponding to a first transmission reception point (TRP) and the second beam failure resource set corresponding to a second TRP.

Embodiment D3. The method of Embodiment D1, receiving the configuration, receiving the activation and determining further comprises one or more of:
receiving the configuration of two CORESETs and the activation of one TCI state via a medium access control (MAC) control element (CE) for each of the two CORESETs; and
determining at least one BFD-RS in a single beam failure resource set.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising processing circuitry configured to:
configure the WD with a plurality of linked control resource sets, CORESETS;
activate a first and a second transmission configuration indicator, TCI, state for each of at least two linked CORESETs of the plurality of linked CORESETs; and
determine a beam failure detection resource set, beam failure detection resource set including at least one beam failure detection reference signal, BFD-RS, a BFD-RS being a reference signal associated with one of the first and second activated TCI states of each of the at least two linked CORESETs of the plurality of linked CORESETs.

2. The network node of claim 1, wherein the reference signal associated with the first and second activated TCI states is a quasi-colocation, QCL, Type D reference signal.

3. The network node of claim 1, wherein the beam failure detection resource set comprises a single beam failure detection resource set including a first BFD-RS being a reference signal associated with the first activated TCI state and a second BFD-RS being a reference signal associated with the second activated TCI state.

4. The network node of claim 1, wherein the plurality of linked CORESETs comprises a second CORESET activated with a third activated TCI state, and a single beam failure detection resource set includes a third BFD-RS being a reference signal associated with the third activated TCI state.

5. The network node of claim 1, wherein the plurality of linked CORESETs comprises a second CORESET activated with a third activated TCI state and a fourth activated TCI state, and a single beam failure detection resource set includes a third BFD-RS being a reference signal associated with the third activated TCI state and a fourth BFD-RS being a reference signal associated with the fourth activated TCI state.

6. The network node of claim 4, wherein the reference signal associated with one of the third and fourth activated TCI states is a quasi-colocation, QCL, Type D reference signal.

7. The network node of claim 1, wherein a first beam failure detection resource set comprises a reference signal of QCL Type D associated with the first activated TCI state.

8. The network node of any of claim 1, wherein a second beam failure detection resource set comprises a reference signal of QCL type D associated with the second activated TCI state.

9. (canceled).

10. (canceled).

11. A method in a network node configured to communicate with a wireless device, WD, the method comprising:
configuring the WD with a plurality of linked control resource sets, CORESETS;
activating a first and a second transmission configuration indicator, TCI, state for each of at least two linked CORESETs of the plurality of linked CORESETs; and
determining a beam failure detection resource set, the beam failure detection resource set including at least one beam failure detection reference signal, BFD-RS, a BFD-RS being a reference signal associated with one of the first and second activated TCI states of each of the at least two linked CORESETs of the plurality of linked CORESETs.

12. The method of claim 11, wherein the reference signal associated with the first and second activated TCI states is a quasi-colocation, QCL, Type D reference signal.

13. The method of claim 11, wherein the beam failure detection resource set comprises a single beam failure detection resource set including a first BFD-RS being a reference signal associated with the first activated TCI state and a second BFD-RS being a reference signal associated with the second activated TCI state.

14. The method of claim 11, wherein the plurality of linked CORESETs comprises a second CORESET activated with a third activated TCI state, and a single beam failure detection resource set includes a third BFD-RS being a reference signal associated with the third activated TCI state.

15. The method of claim 11, wherein the plurality of linked CORESETs comprises a second CORESET activated with a third activated TCI state and a fourth activated TCI state, and a single beam failure detection resource set includes a third BFD-RS being a reference signal associated with the third activated TCI state and a fourth BFD-RS being a reference signal associated with the fourth activated TCI state.

16. The method of claim 14, wherein the reference signal associated with one of the third and fourth activated TCI states is a quasi-colocation, QCL, Type D reference signal.

17. The method of claim 11, wherein a first beam failure detection resource set comprises a reference signal of QCL Type D associated with the first activated TCI state.

18. The method of claim 11, wherein a second beam failure detection resource set comprises a reference signal of QCL type D associated with the second activated TCI state.

19. (canceled).

20. (canceled).

21. A wireless device, WD, configured to communicate with a network node, the WD comprising:
a radio interface configured to receive a configuration of a plurality of linked control resources sets, CORESETs, and an indication of activation of first and a second transmission configuration indicator, TCI, states for each of at least two linked CORESETs of the plurality of linked CORESETs; and
processing circuitry in communication with the radio interface and configured to determine a beam failure detection resource set, the beam failure detection resource set including at least one beam failure detection reference signal, BFD-RS, a BFD-RS being a reference signal associated with one of the first and second activated TCI states of each of the at least two linked CORESETs of the plurality of linked CORESETs.

22. The WD of claim 21, wherein the reference signal associated with the first and second activated TCI states is a quasi-colocation, QCL, Type D reference signal.

23. The WD of claim 21, wherein the beam failure detection resource set comprise a single beam failure detection resource set including a first BFD-RS being a reference signal associated with the first activated TCI states and a second BFD-RS being a reference signal associated with the second activated TCI state.

24. (canceled).

25. A method in wireless device, WD, configured to communicate with a network node, the method comprising:
receiving a configuration of at least one control resource set, CORESET a plurality of linked control resource sets, CORESETs, and an indication of activation of first and a second transmission configuration indicator, TCI, states for one of the at least one CORESET each of at least two linked CORESETs of the plurality of linked CORESETs; and
determining at least one a beam failure detection resource set, the beam failure detection resource set including at least one beam failure detection reference signal, BFD-RS, in at least one beam failure detection resource set, each of the at least one a BFD-RS being a quasi-colocation, QCL, Type D reference signal associated with one of the first and second activated TCI states of each of the at least two linked CORESETs of the plurality of linked CORESETs.

26. The method of claim 25, wherein the reference signal associated with the first and second activated TCI states is a quasi-colocation, QCL, Type D reference signal.

27. The method of claim 25, wherein the beam failure detection resource set comprise a single beam failure detection resource set including a first BFD-RS being a reference signal associated with the first activated TCI states and a second BFD-RS being a reference signal associated with the second activated TCI state.

28. (canceled).
